(19) United States
(12) Patent Application Publication
(10) Pub. No.: US 2005/0184937 A1
(43) Pub. Date: Aug. 25, 2005

(54) [ACTIVE MATRIX OLED DRIVING CONTROL CIRCUIT CAPABLE OF DYNAMICALLY ADJUSTING WHITE BALANCE AND ADJUSTING METHOD THEREOF]

(76) Inventor: I-Shu Lee, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,660

(22) Filed: Jul. 27, 2004

(30) Foreign Application Priority Data
Feb. 20, 2004 (TW) 93104198

(51) Int. Cl. G09G 3/32

(52) U.S. Cl. 345/82; 345/204

(57) ABSTRACT

An active matrix organic light emitting diode (AMOLED) driving control circuit with the capability of dynamically adjusting the white balance of an AMOLED display panel and the adjusting method thereof. A plurality of programmable voltage power sources generated by a programmable voltage power source generator is applied to drive the red, green and blue pixels within the AMOLED display panel. A white balance adjusting circuit is deployed to adjust the voltage value of the programmable voltage sources according to the degree of degradation of light emitting material.

### CROSS REFERENCE TO RELATED APPLICATIONS

This application claims the priority benefit of Taiwan application serial no. 93104198, filed Feb. 20, 2004.

### BACKGROUND OF INVENTION

1. Field of the Invention

The present invention relates to an active matrix organic light-emitting diode (AMOLED) driving control circuit and a driving method. More particularly, the present invention relates to an AMOLED driving control circuit capable of dynamically adjusting white balance and adjusting method thereof.

2. Description of the Related Art

With the rapid improvement in semiconductor fabrication technologies, various types of information processing devices such as personal computers, mobile phones, personal digital assistants and digital cameras have been developed. One of the most prominent components in an information device is the display device. Because a flat panel display is light and slim and consumes very little power, it has gradually become one of the most popular display products.

Active matrix organic light emitting diode (AMOLED) display is a particular type of flat panel display that has many advantages including a wide viewing angle, a good color contrast, a rapid response and a low production cost. At present, many devices requiring a small display such as electronic clocks, mobile phones, personal digital assistants and digital cameras uses AMOLED displays.

However, because materials inside the organic light emitting diodes for generating red (R), green (G) and blue (B) light are different, brightness level of each color may change with prolonged usage. Ultimately, the white balance of the OLED display panel may deteriorate. FIG. 1 shows the curves of brightness level versus lifetime of the three types of high molecular weight light emitting materials for producing red, green and blue light. In FIG. 1, the lighter color curves illustrates the degree of attenuation of the brightness level with time for the red, green and blue high molecular weight light emitting materials. Clearly, the degree of attenuation with time of the three high molecular weight light emitting materials is non-identical. Hence, the brightness level of each color may change after some time leading to a deterioration of the white balance in the display panel.

### SUMMARY OF INVENTION

Accordingly, at least one objective of the present invention is to provide an active matrix organic light emitting diode (AMOLED) driving control circuit capable of dynamically adjusting the white balance of a AMOLED display panel according to its usage status and the adjusting method thereof.

To achieve these and other advantages and in accordance with the purpose of the invention, as embodied and broadly described herein, the invention provides a AMOLED driving control circuit capable of driving an AMOLED display panel and dynamically adjusting the white balance of the AMOLED display panel. The AMOLED driving control circuit comprises a gate driving circuit, a source driving circuit, a programmable voltage generator and a timing control circuit. The gate driving circuit generates a horizontal scan signal for controlling the scan line display of the AMOLED display panel. The source driving circuit integrates with the horizontal scan signal and sends the video data of the display scan line to the AMOLED display panel. The programmable voltage generator generates a plurality of programmable voltage sources serving as the power sources for red, green and blue pixels inside the AMOLED display panel. The timing control circuit is coupled to the gate driving circuit, the source driving circuit and the programmable voltage generator for controlling the timing of video data between the gate driving circuit and the source driving circuit. According to the usage status of the AMOLED display panel, the timing control circuit dynamically adjusts the voltage value of the programmable voltage source so that the white balance of the AMOLED display panel is also adjusted.

In one embodiment of the present invention, the timing control circuit further comprises a source and gate timing data control circuit, an interface processing circuit and a white balance adjusting circuit. The source and gate timing data control circuit controls the timing of video data between the gate driving circuit and the source driving circuit. The interface processing circuit serves as a signal transmission interface. The white balance adjusting circuit is coupled to the source and gate timing data control circuit and the interface processing circuit. The white balance adjusting circuit sets the adjustable parameters for changing the voltage value of the programmable voltage source according to the usage status of the AMOLED display panel and transmits the parameters to the programmable voltage generator via the interface processing circuit.

In one embodiment of the present invention, the usage status of the AMOLED display panel or the degree of material degradation is assessed according to whether the displayed gray level in the video data within a set period exceeds a preset value such as 255 or not. According to the results of the assessment, the values of the adjustable parameters for setting the voltage value of the programmable voltage source are determined. Thus, the white balance adjusting circuit at least comprises a first comparator, a counter, a second comparator, an AND logic unit and a parameter setting unit.

The first comparator compares the video data with the preset data value to produce a first compare signal. The first compare signal is transmitted when the displayed gray level of the input video data is not less than the preset data value. The counter for holding a count value is coupled to the first comparator so that the count value is increased by one on receiving a first compare signal, for example. The second comparator is coupled to the counter for comparing the count value registered by the counter with a preset count value to produce a second compare signal. The second compare signal is transmitted when the number of times the displayed gray level of the video data is not less than the preset data value reaches the set count value. The AND logic unit is coupled to the second comparator for generating an adjusting signal according to the second compare signal after the passage of a designated period. The parameter setting unit is coupled the AND logic unit to set the adjustable parameters for changing the voltage value of the programmable voltage source according to the adjusting signal and transmit the parametric values to the programmable voltage source via the interface processing circuit.

The aforementioned preset data value, preset count value and preset time period can be stored inside a read only memory, an electrically erasable programmable read only memory or a flash memory. The aforementioned interface processing circuit can be a serial transmission interface such as IIC.

The present invention also provides a method of dynamically adjusting the white balance of an active matrix organic light emitting diode (AMOLED) display panel using an AMOLED driving control circuit. The method includes the following steps. First, a plurality of programmable voltage sources is provided to serve as power sources for driving red, green and blue pixels within the AMOLED display panel. Thereafter, according to the usage status of the AMOLED display panel, the voltage value of various programmable voltage sources is dynamically adjusted.

The method of adjusting the voltage value of the programmable voltage source according to the usage status of the AMOLED display panel includes receiving a video data and comparing the video data with a preset data value. When the video data is not less than the preset data value, or in other words, the displayed gray levels of the video data is not less than the preset data value of say 255, the value inside the counter increases by one. Thereafter, the value registered by the counter is compared with a preset counter value. When a preset time period is passed and the value inside the counter is not less than the preset count value, this means that the degree of degradation of the material inside the display panel has already exceeded an acceptable level. Therefore, the voltage value of the programmable voltage sources is adjusted to obtain a better white balance in the AMOLED display panel.

Accordingly, the AMOLED driving control circuit and adjusting method of the present invention is able to adjust the white balance of an AMOLED display panel dynamically in accordance with the degree of degradation of the light emitting material inside the panel. Consequently, the AMOLED display panel can have a better long term white balance.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1(a), (b) and (c) show the curves of brightness level versus lifetime of three types of high molecular weight light emitting materials for producing red, green and blue light.

FIG. 2 is an equivalent diagram showing a pixel circuit of an active matrix organic light emitting diode.

FIG. 3 is a graph showing the characteristic curve of a transistor inside the circuit in FIG. 2.

FIG. 4 is a circuit diagram of an AMOLED driving control circuit for providing a dynamic adjustment of the white balance of an AMOLED display panel according to one embodiment of the present invention.

FIG. 5 is a block diagram of the timing control circuit according to one embodiment of the present invention.

FIG. 6 shows a display panel having a 1024*768 resolution partitioned into 16 regions.

FIG. 7 is a circuit diagram of the white balance adjusting circuit according to one embodiment of the present invention.

FIG. 8 is a flow diagram showing the steps for dynamically adjusting the white balance of an AMOLED display panel using an AMOLED driving control circuit according to one embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

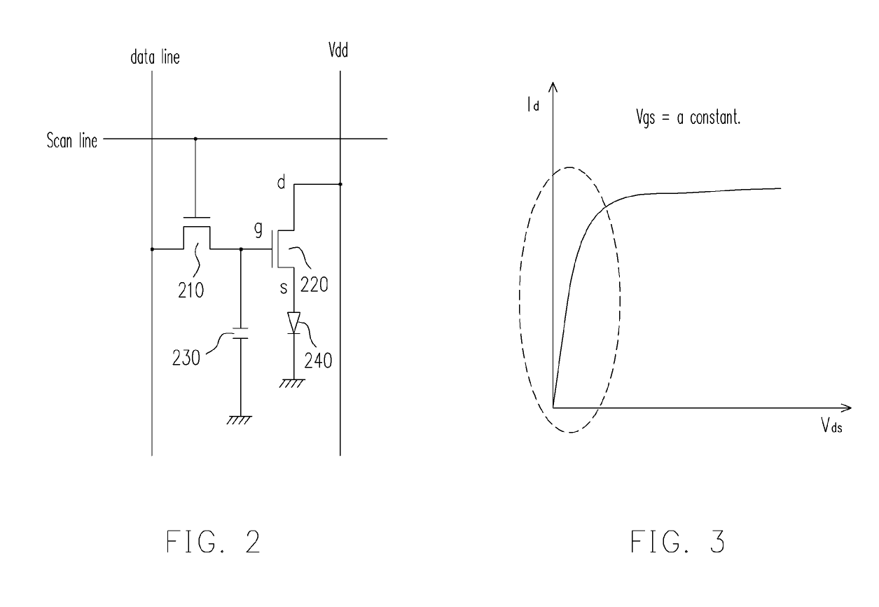

FIG. 2 is an equivalent diagram showing a pixel circuit of an active matrix organic light emitting diode in an AMOLED display panel. As shown in FIG. 2, an active matrix organic light emitting diode (AMOLED) pixel includes a first transistor 210, a second transistor 220, a capacitor 230 and an organic light emitting diode 240. A gate terminal of the first transistor 210 is connected to a scan line and a drain terminal of the first transistor 210 is connected to a data line. A source terminal of the first transistor 210 is connected to one terminal of a capacitor 230 as well as a gate terminal of a second transistor 220. A drain terminal of the second transistor 220 is connected to a voltage source Vdd and a source terminal of the second transistor 220 is connected to an anode of the organic light emitting diode 240.

When a horizontal scan signal applied to the pixel through the scan line, the transistor 210 is turned on so that a voltage Vg on the data line is applied to the gate terminal of the second transistor 220. In general, a brightness level of the organic light emitting diode 240 is proportional to current Id passing through the organic light emitting diode 240. Hence, a displayed gray level of the organic light emitting diode 240 can be controlled by a voltage value representing video data on the data line.

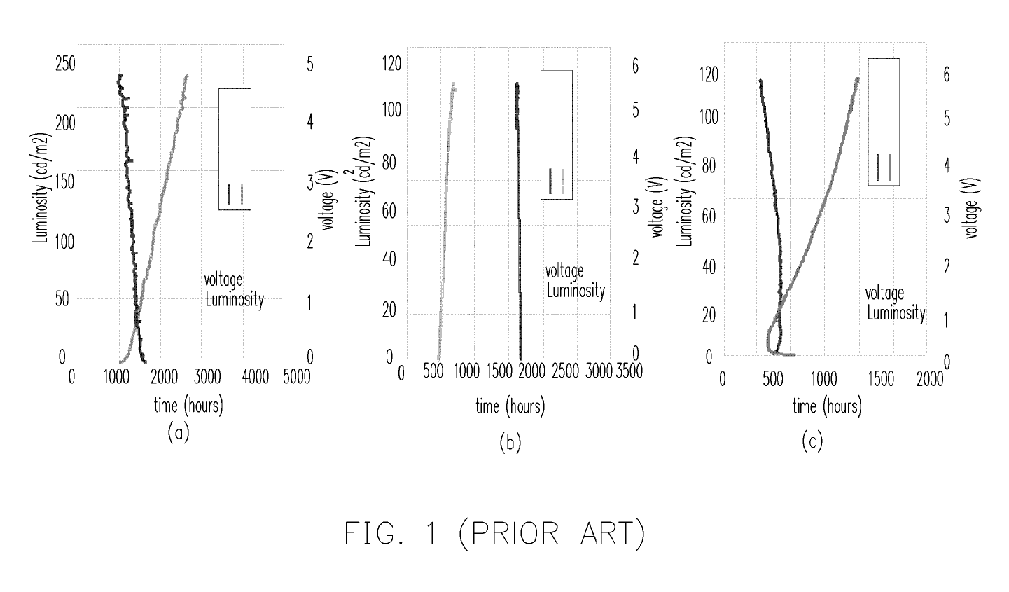

When the AMOLED display panel has been used for a long time (refer to FIG. 1), the brightness level of red, green and blue light may change due to the different degree of degradation of the high molecular weight light emitting materials for producing red, green and blue light. A non-uniformity of brightness level of the three primary colors often leads to problems in white balance. In the present invention, the voltage of the power source Vdd in FIG. 2 can be reset to adjust the size of current Id flowing through the organic light emitting diode 240 so that the actual luminosity of the organic light emitting diode 240 can be changed. The effect of adjusting the supply voltage can be observed from a characteristic current versus voltage curve of the transistor in FIG. 3.

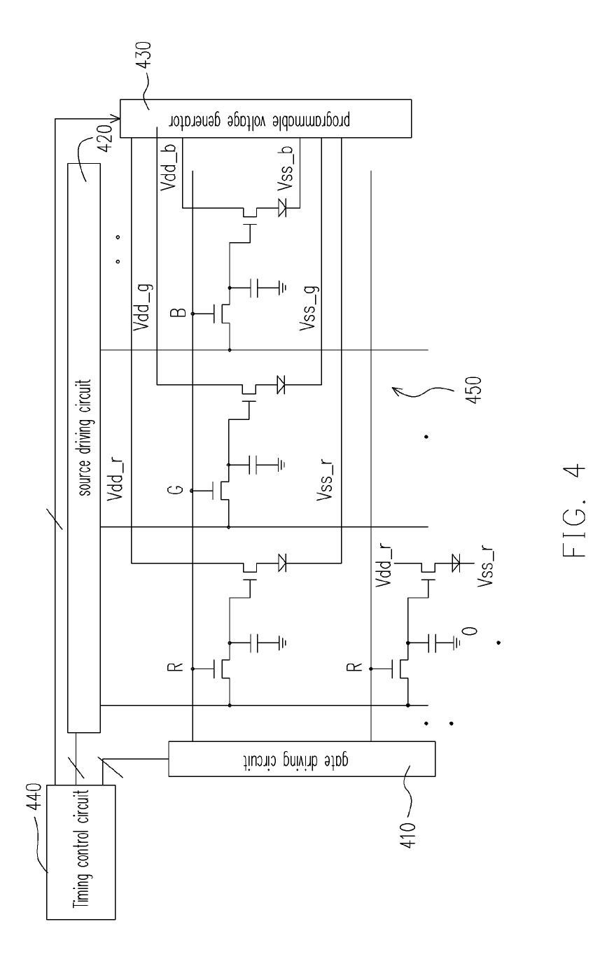

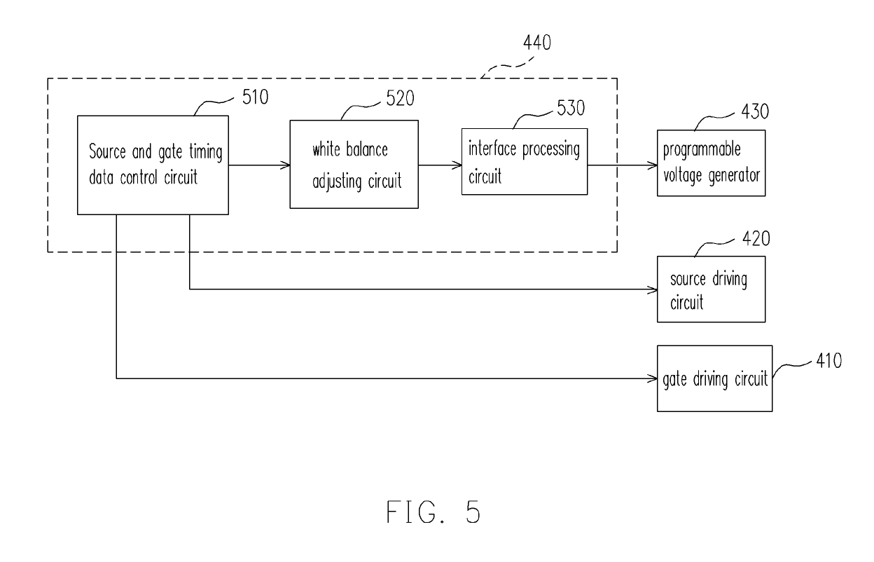

FIG. 4 is a circuit diagram of an AMOLED driving control circuit for providing a dynamic adjustment of the white balance of an AMOLED display panel according to one embodiment of the present invention. As shown in FIG. 4, the AMOLED driving control circuit includes a gate driving circuit 410, a source driving circuit 420, a programmable voltage generator 430 and a timing control circuit 440. The AMOLED driving control circuit drives arrays of red (R), green (G) and blue (B) pixels inside an AMOLED display panel 450.

The gate driving circuit 410 generates a horizontal scan signal for controlling the scan line in the AMOLED display panel 450. The source driving circuit 420 provides a source signal according to video data intent to be displayed transmits to the pixels corresponding to the horizontal scan line within the AMOLED display panel 450. The programmable voltage generator 430 generates a plurality of programmable voltage sources such as Vdd_r and Vss_r, Vdd_g and Vss_g and Vdd_b and Vss_b, which sources serve as the power sources for the red (R), green (G) and blue (B) pixels within the AMOLED display panel 450. The timing control circuit 440 is coupled to the gate driving circuit 410, the source driving circuit 420 and the programmable voltage generator 430 for controlling the timing of the submission of video data between the gate driving circuit 410 and the source driving circuit 420. According to the usage status of the AMOLED display panel 450 such as the display time and the number of pixels having a gray level larger than a fixed value, the voltages at the programmable voltage sources Vdd_r and Vss_r, Vdd_g and Vss_g and Vdd_b and Vss_b are dynamically adjusted so that an ideal white balance is always maintained in the AMOLED display panel 450.

FIG. 5 is a block diagram of the timing control circuit according to one embodiment of the present invention. As shown in FIG. 5, the timing control circuit 440 includes a source and gate timing data control circuit 510, an interface processing circuit 530 and a white balance adjusting circuit 520. The source and gate timing data control circuit 510 controls the timing of the submission of video data between the gate driving circuit 410 and the source driving circuit 420. The interface processing circuit 530 provides a serial transmission interface such as IIC that serves as an interface for signal transmission. The white balance adjusting circuit 520, coupled to the source and gate timing data control circuit 510 and the interface processing circuit 530, is used to adjust the parameters for setting the voltage values of the programmable voltage sources according to the usage status of the AMOLED display panel such as the display time and the number of pixels having a displayed gray level greater than a fixed value. Thereafter, the white balance adjusting circuit 520 transmits the parameters for changing the voltage values to the programmable voltage generator 430 through the interface processing circuit 530.

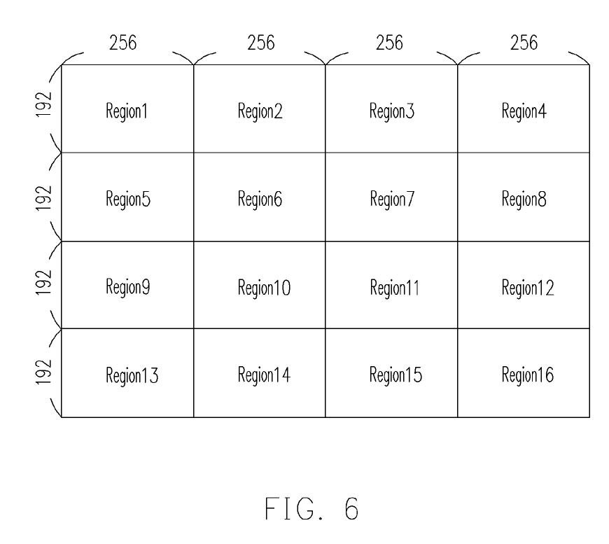

FIG. 6 shows a display panel having a 1024*768 resolution partitioned into 16 regions. According to the circuits in FIGS. 4 and 5 and the AMOLED driving control circuit of the present invention, the voltages at the programmable voltage sources is adjusted based on, for example, the display time and the number of pixels having a displayed gray level higher than a fixed value. To gauge the driving status or the degree of degradation of light emitting materials of the AMOLED display panel more accurately, the white balance adjusting circuit 520 can set the voltage values of the programmable voltage sources precisely, and the AMOLED display panel is partitioned into 16 regions. Each region performs a counting of the number of active matrix organic light emitting diodes subjected to a displayed gray level higher than a fixed value within a designated period. The data thus gathered serves as a base for assessing the degree of degradation in the light emitting material. Clearly, anyone familiar in this field may notice that the AMOLED display panel can be divided into whatever number of counting regions that are desirable.

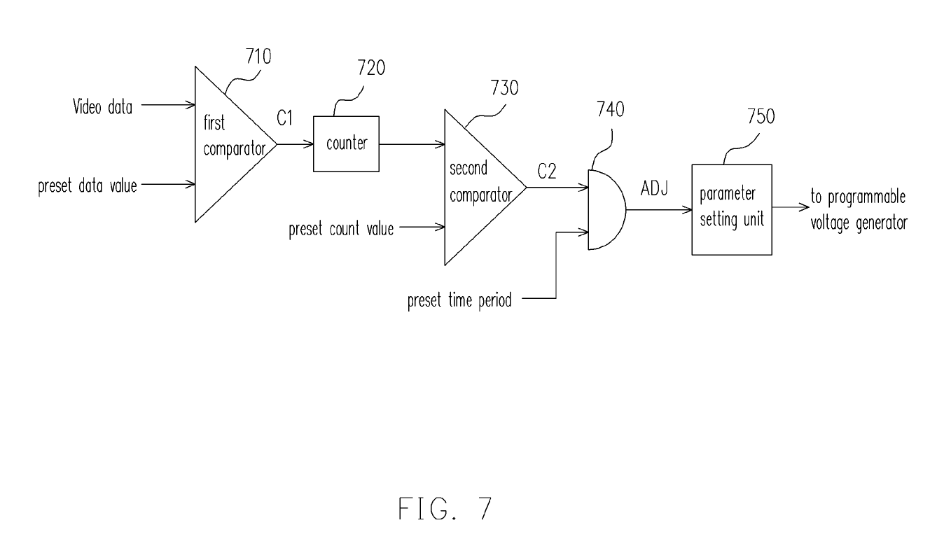

FIG. 7 is a circuit diagram of the white balance adjusting circuit according to one embodiment of the present invention. As shown in FIG. 7, the white balance adjusting circuit at least includes a first comparator 710, a counter 720, a second comparator 730, an AND logic unit 740 and a parameter setting unit 750. Obviously, the first comparator 710, the counter 720, the second comparator 730, the AND logic unit 740 are used for assessing the preset time period and preset count value status within one AMOLED display panel region. To detect the status in more regions, the number of comparators and counters must be increased accordingly.

In FIG. 7, the first comparator 710 is used to compare the video data to be displayed with a preset data value such as 255 and generate a first compare signal C1. The first compare signal C1 is produced when the displayed gray level of the input video data is not less than the preset data value signal. Here, if a preset data value having a gray level of 255 is used as a reference, all the 8-bit displayed played video data having the largest degree of material degradation can be detected.

In addition, the counter 720 is coupled to the first comparator 710 for updating the count value inside the counter 720 when a first compare signal C1 arrives. For example, on receiving a compare signal C1 from the first comparator 710, the count value inside the counter 720 is increased by one. The second comparator 730 is coupled to the counter 720 for comparing the count value inside the counter 720 with a preset count value and generating a second compare signal C2. In other words, the second comparator 730 checks to determine if the number of displayed video data having a gray level not less than the preset data value exceeds the preset count value. The AND logic unit 740 is coupled to the second comparator 730 for generating an adjusting signal ADJ according to the second compare signal C2 after a preset period has passed. The parameter setting unit 750 is coupled to the AND logic unit 740 for adjusting the parameters for setting the voltage values of the programmable voltage sources according to the adjusting signal ADJ and then sending the parameters to the programmable voltage generator 430 via the interface processing circuit 530.

In the present embodiment, the preset data value, the preset count value and the preset time period can be stored inside a read only memory (ROM), an electrically erasable programmable read only memory (EEPROM) or a flash memory, for example. Moreover, all these values are read out from the memory to serve as compare data each time the AMOLED display panel is activated.

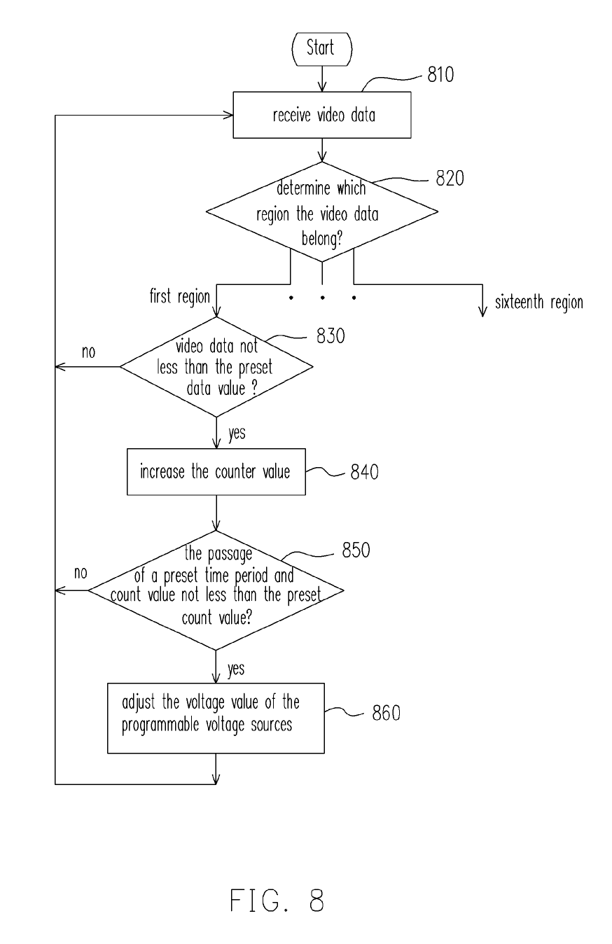

FIG. 8 is a flow diagram showing the steps for dynamically adjusting the white balance of an AMOLED display panel using an AMOLED driving control circuit according to one embodiment of the present invention. The present method is capable of dynamically adjusting the white balance of an AMOLED display panel. First, a plurality of programmable voltage sources is provided to serve as the power sources for red, green and blue pixels inside the AMOLED display panel. Thereafter, according to the usage status of the AMOLED display panel, the voltage values of various programmable voltage sources are dynamically adjusted. The aforementioned AMOLED display panel is partitioned into 16 regions. Since the steps carried out to adjust the pixels in each region are identical, FIG. 8 illustrates the steps for adjusting the pixels within a first region only.

In step 810, a video data is fetched from an external source. In step 820, the video data is checked to determine which region within the AMOLED display panel it belongs. Thereafter, the flow is branched to whichever region the video data is found to belong. For example, if the video data is determined to belong to the first region of the AMOLED display panel, step 830 is executed so that the video data is compared with a preset data value with a gray level 255. When the video data is not less than the preset data value, step 840 is executed to increase a count value. In step 850, the count value is compared with a preset count value to determine whether the count value is smaller than the preset count value or not when a preset time limit has passed. If the count value is found to be not less than the preset count value after the passage of the preset time limit, the deterioration of the light emitting material inside the AMOLED display panel is considered to be beyond an acceptable level. In this case, step 860 is executed to adjust the voltage values of various programmable voltage sources and provide the AMOLED display panel with a better white balance. Obviously, the preset time limit and the preset count value serving as reference values can be changed according to the actual requirements. In addition, a set of preset time limits and preset count values may also be used.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An active matrix organic light emitting diode (AMOLED) driving control circuit for dynamically adjusting the white balance of an AMOLED display panel, comprising:
a gate driving circuit for generating a horizontal scan signal to control a scan line of the AMOLED display panel;
a source driving circuit for applying a video data to the AMOLED display panel according to the horizontal scan signal;
a programmable voltage generator for generating a plurality of programmable voltage sources that serves as power sources for driving red, green and blue pixels within the AMOLED display panel; and
a timing control circuit coupled to the gate driving circuit, the source driving circuit and the programmable voltage generator for controlling the timing of the submission of the video data between the gate driving circuit and the source driving circuit and dynamically adjusting the voltage value of the programmable voltage sources according to the usage status of the AMOLED display panel.

2. The AMOLED driving control circuit of claim 1, wherein the timing control circuit comprises:
a source and gate timing data control circuit for controlling the timing of the submission of the video data between the gate driving circuit and the source driving circuit;
an interface processing circuit serving as a signal transmission interface; and
a white balance adjusting circuit coupled to the source and gate timing data control circuit and the interface processing circuit for adjusting the parameters for setting the voltage value of the programmable voltage sources according to the usage status of the AMOLED display panel and submitting the parameters to the programmable voltage generator through the interface processing circuit.

3. The AMOLED driving control circuit of claim 2, wherein the white balance adjusting circuit at least comprises:
a first comparator for comparing the video data with a preset data value and generating a first compare signal;
a counter coupled to the first comparator for counting a count value based on the first compare signal;
a second comparator coupled to the counter for comparing the count value with a preset count value and generating a second compare signal;
an AND logic unit coupled to the second comparator for generating an adjusting signal based on the second compare signal after the passage of a preset time period; and
a parameter setting unit coupled to the AND logic unit for providing the parameter for setting the voltage value of the programmable voltage sources according to the adjusting signal and transmitting the parameter to the programmable voltage generator through the interface processing circuit.

4. The AMOLED driving control circuit of claim 3, wherein the preset data value, the preset count value and the preset time period are stored inside a read only memory unit.

5. The AMOLED driving control circuit of claim 3, wherein the preset data value, the preset count value and the preset time period are stored inside an electrically erasable programmable read only memory unit.

6. The AMOLED driving control circuit of claim 3, wherein the preset data value, the preset count value and the preset time period are stored inside a flash memory unit.

7. The AMOLED driving control circuit of claim 2, wherein interface processing circuit comprises a serial transmission interface.

8. A method of dynamically adjusting the white balance of an active matrix organic light emitting diode (AMOLED) display panel using an AMOLED driving control circuit, comprising:
providing a plurality of programmable voltage sources to serve as power sources for driving red, green and blue pixels within the AMOLED display panel; and
adjusting the voltage value of the programmable voltage sources dynamically according to the usage status of the AMOLED display panel.

9. The adjusting method of claim 8, wherein the step of adjusting the voltage value of the programmable voltage sources dynamically according to the usage status of the AMOLED display panel comprises:
receiving a video data;
comparing the video data with a preset data value;
increasing the value inside a counter when the video data is not less than the preset data value;
comparing the counter value with a preset count value; and
adjusting the voltage value of the programmable voltage sources after the passage of a preset time period when the count value is not less than the preset count value.
